(19) United States
(12) Patent Application Publication
(10) Pub. No.: US 2015/0286045 A1
(43) Pub. Date: Oct. 8, 2015

(54) MULTI-LENS MAGNIFIER AND CASE

(71) Applicant: HON HAI PRECISION INDUSTRY CO., LTD., New Taipei (TW)

(72) Inventor: TUNG-FA HO, New Taipei (TW)

(21) Appl. No.: 14/675,883

(22) Filed: Apr. 1, 2015

(30) Foreign Application Priority Data
Apr. 3, 2014 (CN) 201410132833.3

(51) Int. Cl. G02B 25/00

(52) U.S. Cl. CPC G02B 25/008

(57) ABSTRACT

A multi-lens magnifier and case includes a housing and a first lens. The housing defines an opening and a first guiding slot. The first lens is rotatably received in the housing. A first operation portion is coupled to the first lens. The first operation portion is received in the first guiding slot and partially protrudes out of the housing. The first operation portion is configured to slide in the first guiding slot and to rotate the first lens.

### FIELD

The subject matter herein generally relates to multi-lens magnifier and cases, and particularly to a portable multi-lens magnifier and case.

### BACKGROUND

When text on a book or an electronic device is in an improper size, it is inconvenient to read. After reading for a while, the reader's eyes will be tired.

### BRIEF DESCRIPTION OF THE DRAWINGS

Implementations of the present technology will now be described, by way of example only, with reference to the attached figures.

FIG. 1 is an exploded, isometric view of an embodiment of a multi-lens magnifier and case.

FIG. 2 is a partially exploded, isometric view of the multi-lens magnifier and case of FIG. 1.

FIG. 3 is an assembled, isometric view of an embodiment of a multi-lens magnifier and case.

FIG. 4 is an isometric view of the multi-lens magnifier and case in a first use state of FIG. 1.

FIG. 5 is an isometric view of the multi-lens magnifier and case in a second use state of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is in relation to a multi-lens magnifier and case that can include a housing and a first lens. The housing can define an opening and a first guiding slot. The first lens can be rotatably received in the housing. A first operation portion can be coupled to the first lens. The first operation portion can be received in the first guiding slot and partially protrudes out of the housing. The first operation portion can be configured to slide in the first guiding slot to rotate the first lens.

The present disclosure is in relation to a multi-lens magnifier and case that can include a housing, a first lens, and a second lens. The housing can define an opening, a first guiding slot, and a second guiding slot. The first lens can be rotatably coupled to the housing. A first operation portion can be coupled to the first lens. The second lens can be rotatably coupled to the housing. The second lens can define a sliding slot aligned to the first guiding slot. A second operation can be coupled to the second lens and received in the second guiding slot. The first operation portion can be received in the first guiding slot and the sliding slot. The first operation portion can be configured to slide in the first guiding slot and the sliding slot to rotate the first lens. The second operation portion can be configured to slide in the second guiding slot to rotate the second lens.

The present disclosure is in relation to a multi-lens magnifier and case can include a housing, a first lens, and a second lens. The housing can include a top wall, a bottom wall, a first sidewall, a second sidewall, and a third sidewall. The bottom wall can be opposite, and substantially parallel, to the top wall. The first sidewall can be substantially perpendicular to the top wall and the bottom wall. The second sidewall can be substantially perpendicular to, the top wall and the bottom wall and opposite, and substantially parallel, to the first sidewall. The third sidewall can be substantially perpendicular to, the top wall and the bottom wall and substantially perpendicular to the first sidewall and the second sidewall. The top wall, the bottom wall, the first sidewall, the second sidewall and the third sidewall can cooperate to form a receiving space with a defined opening. The first lens can be pivotably attached to the housing and substantially receivable within the receiving space. The second lens can be pivotably attached to the housing and substantially receivable within the receiving space. The first guiding slot and a second guiding slot can be defined in the top wall of the housing and a sliding slot can be defined in the second lens. The first lens can be coupled to a first operation portion and the second lens can be coupled to a second operation portion. The first operation portion can be received in the first guiding slot and the second sliding slot and configure to slide within the first guiding slot and the second sliding slot to rotate the first lens from the receiving space. The second operation portion can be received in the second guiding slot and configure to slide within the second guiding slot to rotate the second lens from the receiving space.

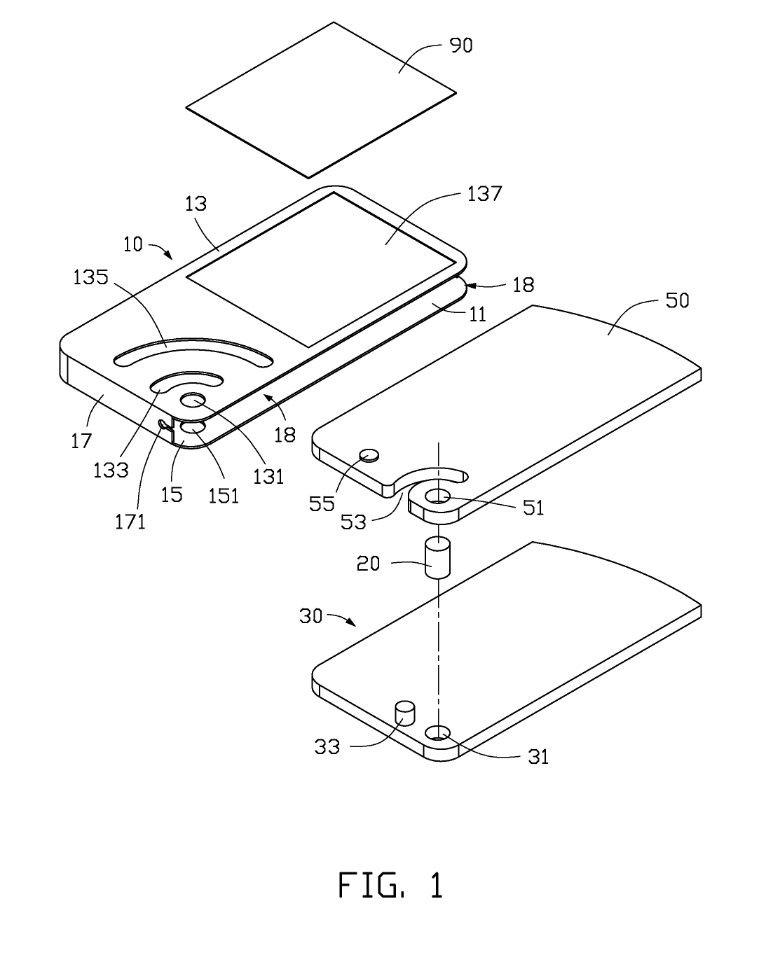

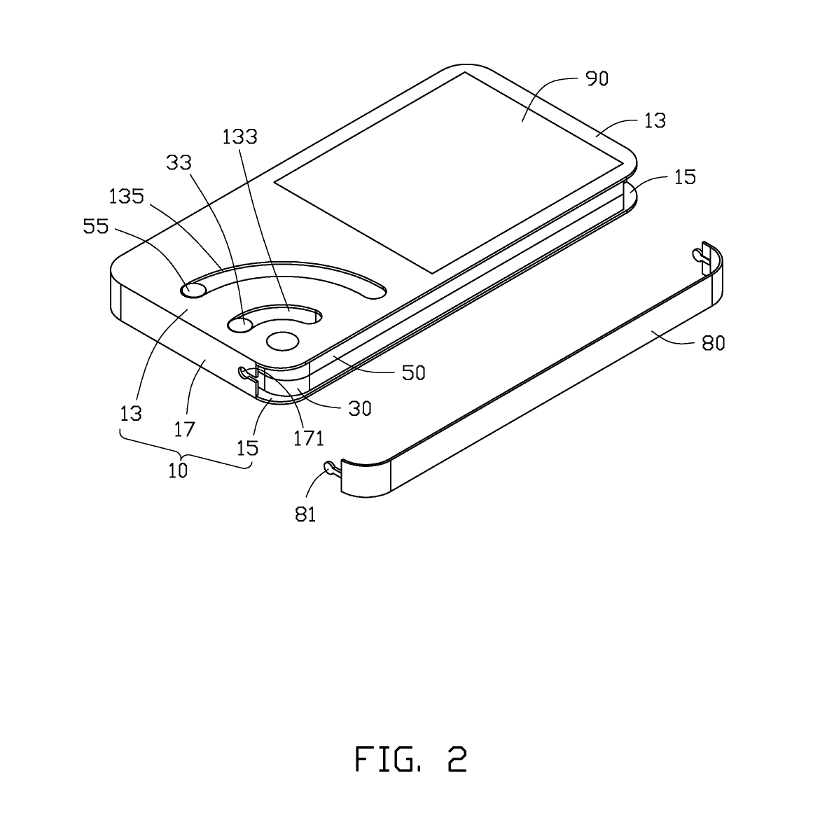

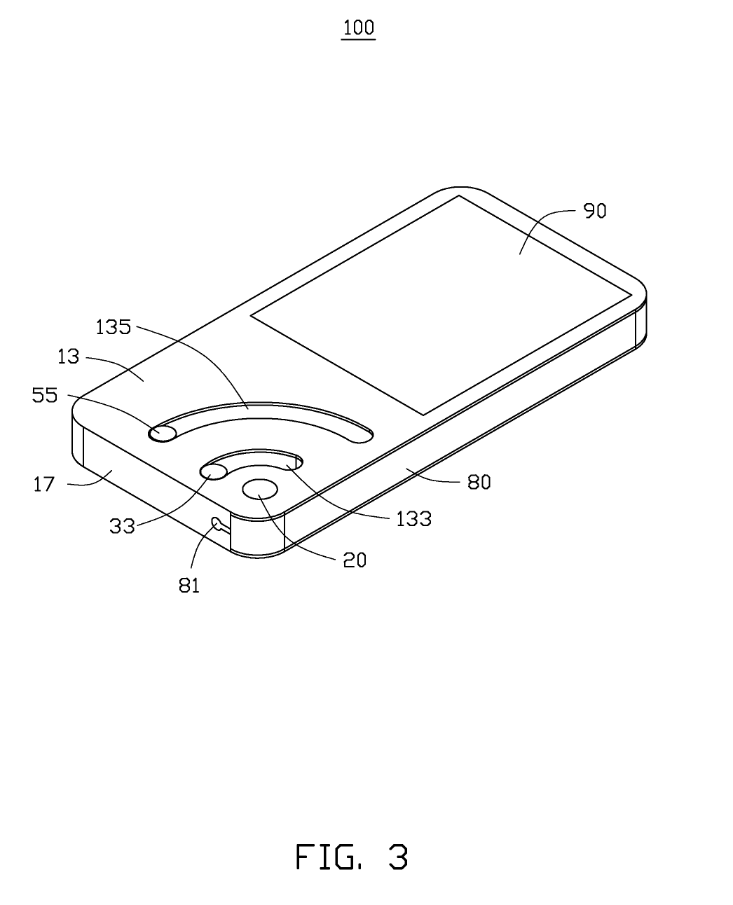

FIG. 1 illustrates an embodiment of a multi-lens magnifier and case 100. The multi-lens magnifier and case 100 can include a housing 10, a pivoting member 20 coupled to the housing 10, a first lens 30, a second lens 50, a side cover 80 (shown in FIGS. 2 and 3), and a third lens 90. The housing 10 can define an opening 11 at a sidewall thereof. The first lens 30 and the second lens 50 can be received in the housing 10 and can be rotatable relative to the housing 10. The side cover 80 can detachably cover the opening 11. The third lens 90 can be mounted on the housing 10. In at least one embodiment, the housing 10 can be made of ABS (Acrylonitrile Butadiene Styrene). The first lens 30 and the second lens 50 can be made of PMMA (polymethyl methacrylate). In the illustrated embodiment, the multi-lens magnifier and case 100 is a reading assistant device.

The housing 10 can be a substantially rectangular housing. The housing 10 can include a top wall 13, a bottom wall 15, and three sidewalls 17 positioned between the top wall 13 and the bottom wall 15. Each of the top wall 13 and the bottom wall 15 can be a substantially rectangular plate. The top wall 13 and the bottom wall 15 can be substantially parallel to each other. The sidewalls 17 can be substantially perpendicular to the top wall 13 and the bottom wall 15. Each sidewall 17 can be coupled to an edge of the top wall 13 and an edge of the bottom wall 15. The top wall 13, the bottom wall 15, and the sidewalls 17 can define a receiving chamber 18, cooperatively. The opening 11 can be in fluid communication with the receiving chamber 18.

The top wall 13 can define a first through hole 131 at a corner adjacent to the opening 11 thereof. The bottom wall 15 can define a second through hole 151 at a corner adjacent to the opening 11 thereof. The first through hole 131 can be aligned to the second through hole 151.

The top wall 13 can further define a first guiding slot 133 and a second guiding slot 135 adjacent to the first guiding hole 131. The first guiding slot 133 can be positioned between the first through hole 131 and the second guiding slot 135. The first guiding slot 133 and the second guiding slot 135 can be substantially arcuate. In the illustrated embodiment, the first guiding slot 133 and the second guiding slot 135 can be substantially circular, and the first through hole 131 can be a center point of the circular first guiding slot 133 and the circular second guiding slot 135.

The top wall 13 can further define a window 137 thereon. The window 137 can be substantially rectangular and can be configured to couple the third lens 90. Two of the sidewalls 17 which substantially parallel to each other can each define a latching slot 171 (only one latching slot is shown in FIG. 1 and another one is blocked by the top wall). The latching slots 171 can be positioned adjacent to the opening 11 and be in fluid communication with the opening 11 and the receiving chamber 18.

The pivoting member 20 can be rotatably coupled to the housing and partially received in the receiving chamber 18. A first end portion of the pivoting member 20 can be inserted into the first through hole 131. A second end portion of the pivoting member 20 can be inserted into the second through hole 151. Thus, the pivoting member 20 can be a center point of the circular first guiding slot 133 and the circular second guiding slot 135. In at least one embodiment, the pivoting member 20 can be a pin.

The first lens 30 and the second lens 50 can be substantially rectangular. The first lens 30 and the second lens 50 can be received in the receiving chamber 18. The second lens 50 can be stacked on the first lens 30. The first lens 30 can be positioned adjacent to the bottom wall 15. The second lens 50 can be positioned adjacent to the top wall 13.

The first lens 30 can define a first coupling hole 31 at a corner adjacent to the opening 11. The first coupling hole 31 can be aligned with the first through hole 131 and the second through hole 151. The pivoting member 20 can be inserted into the first coupling hole 31, which enable the first lens 30 to be rotatable around the pivoting member 20. A first operation portion 33 can be coupled to the first lens 30 and be adjacent to the first coupling hole 31. The first operation portion 33 can be substantially a post protruding from the first lens 30 towards the top wall 13. The first operation portion 33 can pass through the second lens 50 and the first guiding slot 133, and partially protrude out of the housing 10. When an operator moves the first operation portion 33 along the first guiding slot 133, the first lens 30 can rotate around the pivoting member 20. In at least one embodiment, the first lens 30 can be a concave lens.

The second lens 50 can be positioned above the first lens 30. The second lens 50 can define a second coupling hole 51 at a corner adjacent to the opening 11. The second coupling hole 51 can be aligned with the first through hole 131, the second through hole 151, and the first coupling hole 31. The pivoting member 20 can be further inserted into the second coupling hole 51, which enable the second lens 50 to be rotatable around the pivoting member 20. The second lens 50 can further define a sliding slot 53. The sliding slot 53 can be positioned adjacent to the second coupling hole 51 and substantially accurate. The sliding slot 53 can be aligned to the first guiding slot 133. An end portion of the sliding slot 53 can run through an edge of the second lens 50. The first operation portion 33 can be received in the sliding slot 53 and the first guiding slot 133. The first operation portion 33 can be configured to slide along the sliding slot 53 and the first guiding slot 133. In the illustrated embodiment, the second coupling hole 51 can be a center point of the sliding slot 53. A length of the first guiding slot 133 can be substantially equal to a length of the sliding slot 53. A radian of the first guiding slot 133 can be substantially equal to a radian of the sliding slot 53.

A second operation portion 55 can be coupled to the second lens 50 and be adjacent to the sliding slot 53. The first operation portion 33 can be substantially a post protruding from the second lens 50 towards the top wall 13. The second operation portion 55 and the second coupling hole 51 can be positioned at opposite sides of the sliding slot 53. The second operation portion 55 can be received in the second guiding slot 135, and partially protrude out of the housing 10. When an operator moves the second operation portion 55 along the second guiding slot 135, the second lens 50 can rotate around the pivoting member 20. In at least one embodiment, the second lens 50 can be a convex lens.

FIG. 2 illustrates that the side cover 80 can be detachably coupled to the housing 10 and can cover the opening 11. The side cover 80 can be substantially U-shaped and can include two latching portions 81 positioned at opposite ends thereof. The latching portions 81 can be correspond to the two latching slots 171 of the housing 10, respectively.

FIG. 3 illustrates that each latching portion 81 can be detachably received in the corresponding latching slot 171. Thus, the side cover 80 can be detachably coupled to the housing 10. When the multi-lens magnifier and case is not in use, the cover 80 can be configured to protect the first lens 30 and the second lens 50 received in the housing 10.

The third lens 90 can be substantially flat and can be received in the window 137 of the top wall 13. In at least one embodiment, the third lens 90 can be a plane mirror.

When in assembly, the second lens 50 can be stacked on the first lens 30 and the first coupling hole 31 can be aligned to the second coupling hole 51. The first operation 33 of the first lens 30 can be received in the sliding slot 53 of the second lens 50. The first lens 30 and the second lens 50 can be put into the receiving chamber 18. The first through hole 131, the first coupling hole, the second coupling hole 51, and the second through hole 133 can be aligned to each other. The sliding slot 53 can be aligned to the first guiding slot 133. The first operation portion 33 can be received in the sliding slot 53 and the first guiding slot 133. The second operation portion 55 can be received in the second guiding slot 135. The pivoting member 20 can be inserted into the first through hole 131, the first coupling hole 31, the second coupling hole 51, and the second through hole 151. Thus, the first lens 30 and the second lens 50 can be rotatably coupled to the housing 10. The side cover 80 can cover the opening 11. The third lens 90 can be mounted on the window 137 of the top wall 13.

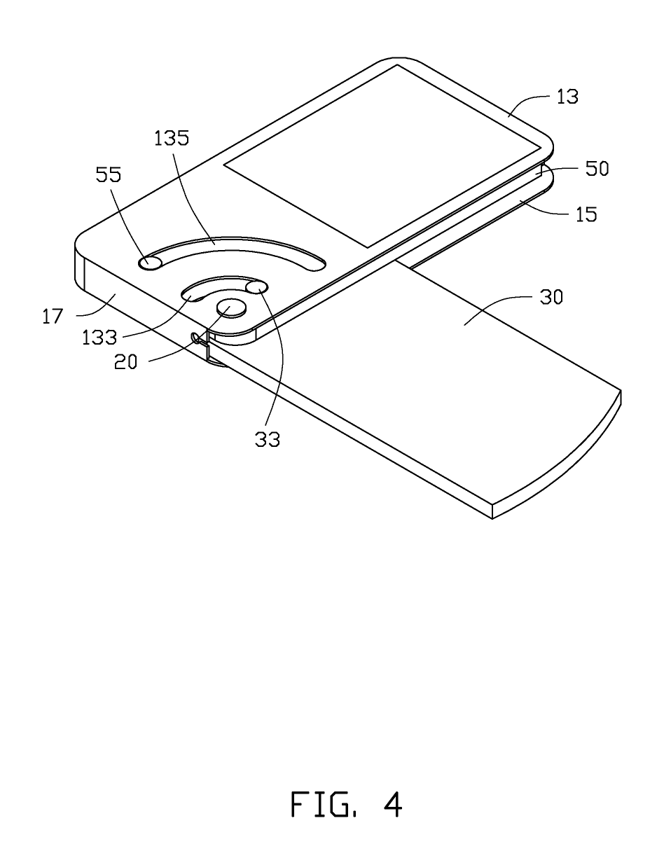

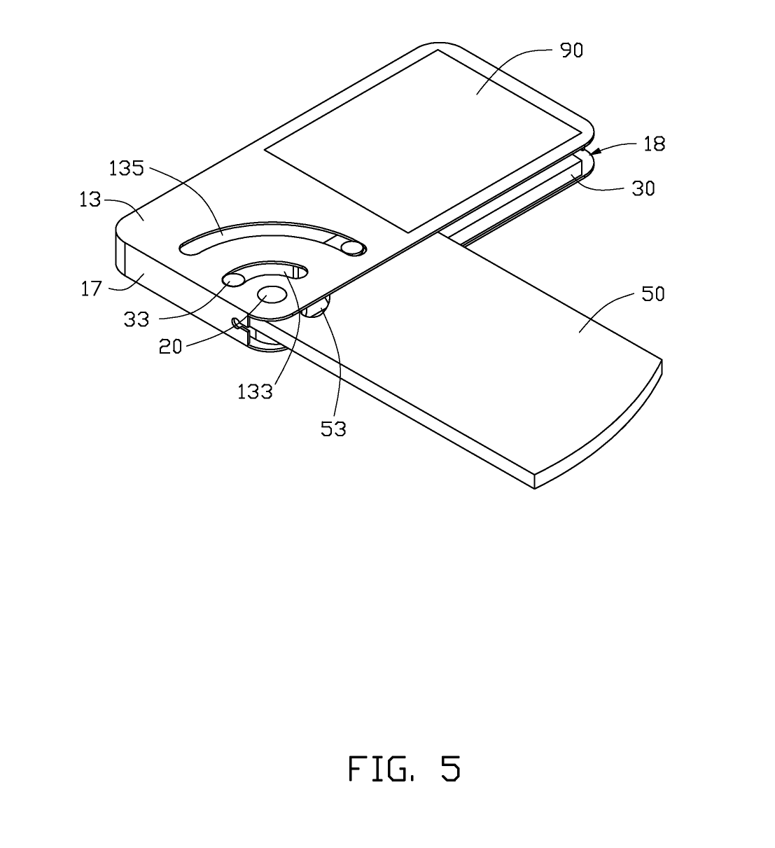

FIG. 4 illustrates that the side cover 80 can be moved away from the housing 10 and the first lens 30 can be rotated to expose from the housing 10. Thus, the first lens 30 can be configured to shrink text size. FIG. 5 illustrates that the second lens 50 can be rotated to expose from the housing 10. Thus, the second lens 50 can be configured to enlarge text size.

In at least one embodiment, the third lens 90 and the side cover 80 can be omitted. The first lens 30 can be a convex lens and the second lens 50 can be a concave lens. The first lens 30 or the second lens 50 can be other types of lens, such as a sunglass.

The embodiments shown and described above are only examples. Many details are often found in the art such as the other features of a multi-lens magnifier and case. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A multi-lens magnifier and case comprising:
a housing defining an opening, a first guiding slot, and a second guiding slot;
a first lens rotatably coupled to the housing, a first operation portion coupled to the first lens; and
a second lens rotatably coupled to the housing, the second lens defining a sliding slot aligned to the first guiding slot, a second operation coupled to the second lens and received in the second guiding slot,
wherein the first operation portion is received in the first guiding slot and the sliding slot, the first operation portion is configured to slide in the first guiding slot and the sliding slot and to rotate the first lens; the second operation portion is configured to slide in the second guiding slot and to rotate the second lens.

2. The multi-lens magnifier and case of claim 1, further comprising:
a pivoting member coupled to the housing,
wherein the first guiding slot and the second guiding slot are substantially circular, and the pivoting member is a center point of the circular first guiding slot and the circular second guiding slot.

3. The multi-lens magnifier and case of claim 2, wherein the first lens defines a first coupling hole, the second lens defines a second coupling hole aligned to the first coupling hole, the pivoting member is inserted into the first coupling hole and the second coupling hole.

4. The multi-lens magnifier and case of claim 2, wherein the pivoting member is a pin.

5. The multi-lens magnifier and case of claim 2, wherein the housing comprises a top wall, a bottom wall, and three sidewalls positioned between the top wall and the bottom wall, the top wall, the bottom wall, and the sidewalls define a receiving chamber, cooperatively, the second lens is stacked on the first lens, the first lens and the second lens are received in the receiving chamber.

6. The multi-lens magnifier and case of claim 5, wherein the first guiding slot and the second guiding slot are defined on the top wall.

7. The multi-lens magnifier and case of claim 5, wherein the top wall defines a first through hole, the bottom wall defines a second through hole aligned to the first through hole, a first end portion of the pivoting member is inserted into the first through hole, a second end portion of the pivoting member is inserted into the second through hole.

8. The multi-lens magnifier and case of claim 5, further comprising:
a side cover comprising two latching portions at opposite ends,
wherein two of the three sidewalls which substantially parallel to each other each defines a latching slot, each latching portion is configured to be detachably received in the corresponding latching slot.

9. The multi-lens magnifier and case of claim 5, further comprising a third lens, the top wall defines a window, and the third lens is received in the window.

10. The multi-lens magnifier and case of claim 9, wherein the third lens is a plane mirror.

11. The multi-lens magnifier and case of claim 1, wherein the first lens is a concave lens.

12. The multi-lens magnifier and case of claim 1, wherein the second lens is a convex lens.

13. The multi-lens magnifier and case of claim 1, wherein sliding slot is substantially arcuate.

14. A multi-lens magnifier and case comprising:
a housing defining an opening and a first guiding slot; and
a first lens rotatably received in the housing, a first operation portion coupled to the first lens, the first operation portion received in the first guiding slot and partially protrude out of the housing, the first operation portion configured to slide in the first guiding slot and to rotate the first lens.

15. The multi-lens magnifier and case of claim 14, further comprising:
a second lens rotatably coupled to the housing, the second lens defining a sliding slot aligned to the first guiding slot, a second operation coupled to the second lens,
wherein the housing further defines a second guiding slot, the second operation is received in the second guiding slot and partially protrude out of the housing.

16. The multi-lens magnifier and case of claim 15, further comprising:
a pivoting member coupled to the housing,
wherein the first lens defines a first coupling hole, the second lens defines a second coupling hole aligned to the first coupling hole, the pivoting member is inserted into the first coupling hole and the second coupling hole.

17. The multi-lens magnifier and case of claim 15, wherein the housing comprises a top wall, a bottom wall, and three sidewalls positioned between the top wall and the bottom wall, the top wall, the bottom wall, and the sidewalls define a receiving chamber, cooperatively, the second lens is stacked on the first lens, the first lens and the second lens are received in the receiving chamber.

18. The multi-lens magnifier and case of claim 14, further comprising a side cover detachably coupled to the housing and configured to cover the opening.

19. The multi-lens magnifier and case of claim 14, further comprising a third lens coupled to the housing.

20. A multi-lens magnifier and case comprising:
a housing having:
a top wall;
a bottom wall opposite, and substantially parallel, to the top wall;
a first sidewall substantially perpendicular to, the top wall and the bottom wall;
a second sidewall substantially perpendicular to, the top wall and the bottom wall and opposite, and substantially parallel, to the first sidewall; and
a third sidewall substantially perpendicular to, the top wall and the bottom wall and substantially perpendicular to the first sidewall and the second sidewall,
the top wall, the bottom wall, the first sidewall, the second sidewall and the third sidewall cooperating to form a receiving space with a defined opening;
a first lens pivotably attached to the housing and substantially receivable within the receiving space; and
a second lens pivotably attached to the housing and substantially receivable within the receiving space;
wherein, a first guiding slot and a second guiding slot is defined in the top wall of the housing and a sliding slot is defined in the second lens;
wherein, the first lens is coupled to a first operation portion and the second lens is coupled to a second operation portion;
wherein, the first operation portion is received in the first guiding slot and the second sliding slot and configure to slide within the first guiding slot and the second sliding slot to rotate the first lens from the receiving space; and
wherein, the second operation portion is received in the second guiding slot and configure to slide within the second guiding slot to rotate the second lens from the receiving space.
